(19) United States
(12) Patent Application Publication
(10) Pub. No.: US 2010/0101108 A1
(43) Pub. Date: Apr. 29, 2010

(54) METHOD AND INSTALLATION FOR SCREENING AND DRYING STRAND MATERIAL UPSTREAM OF A DISTRIBUTION MACHINE IN THE COURSE OF MANUFACTURING WOOD MATERIAL BOARDS

(75) Inventors: Gernot von HAAS, Heidelberg (DE); Tobias Schmucker, Karlsruhe-Durlach (DE)

Correspondence Address: FOLEY AND LARDNER LLP;SUITE 500, 3000 K STREET NW, WASHINGTON, DC, 20007, US

(73) Assignee: Dieffenbacher GmbH + Co. KG

(21) Appl. No.: 12/558,988

(22) Filed: Sep. 14, 2009

(30) Foreign Application Priority Data
Sep. 15, 2008 (DE) DE102008047168.2

(51) Int. Cl. F26B 7/00; F26B 13/00; F26B 19/00

(52) U.S. Cl. 34/381; 34/659; 34/60

(57) ABSTRACT

A method and an installation or machine for screening and drying strand material. The strand material still in the moist state is screened with a screening device into at least two different fractions of strand material. At least one of the screened fractions is fed to at least one dryer, and the feeding of the strand material to the dryer is carried out by means of a conveying device, which is controlled by a control unit. The control unit assures a uniform, predetermined weight and/or volume input into the dryer(s) by measuring the mass and/or the weight per unit area of the strand material by means of a measuring device.

### CROSS-REFERENCE TO RELATED PATENT APPLICATIONS

This application claims priority to German Application DE 10 2008 047 168.2, filed Sep. 15, 2008, which is incorporated herein by reference in its entirety, including the specification, drawings, claims and abstract.

### TECHNOLOGICAL BACKGROUND

Disclosed is a method for screening and drying strand material upstream of a distribution machine in the course of manufacturing wood material boards. Furthermore, an installation or machine for screening and drying strand material upstream of a distribution machine in the course of manufacturing wood material boards is disclosed.

Meanwhile, chip boards with oriented or non-oriented layers and the manufacture of wood material boards from, for example, medium density fibers are automated processes and have already been used for many years in many countries. As described in “Wood Materials, Manufacturing and Processing [Holzwerkstoffe, Herstellung and Verarbeitung]” by Hansgert Soimé, DRW Verlag, 1995, pages 17 ff., the processed chips or fibers are compressed either continuously or in a cycle-dependent manner. Even though, besides the many parts of the installation or machine upstream and downstream of the press, the manufacture of a pressed material mat by means of distribution machines plays a pivotal part, the quality of the pressed material mat that is produced is an important factor, in addition to the quality of the raw material.

In the industrial manufacture of wood material boards continuously operating presses are used. In the case of these presses, as described in DE 39 13 991 C2, the press force is transferred by means of hydraulic actuators to the pressing and heating platens and then over steel bands, which are arranged so as to revolve in a supported manner over a roller body carpet (rolling bars), to the press material. Of course, the use of cycle presses is also available to the person skilled in the art.

Recently it has been demonstrated that several important factors define the cubic meter price of a wood material board, on which the respective producer has a vanishingly small, if any, influence. These factors would include the energy costs (electricity, oil, gas), the material costs (wood and adhesive) and the installation or machine costs (parts, personnel). In order to be competitive on the market, a wood material board manufacturer must hold the rising energy costs and the rising costs of materials as low as possible by buying cheaply. In the case of the adhesive, the wood material board producer is usually dependent on a small number of adhesive manufacturers, who demand similar prices. Due to the rising demand for raw materials on the world market in general and the rising demand for wood in the individual case, the cost of these raw materials continues to escalate. At this point the producers are forced to make the production process more cost competitive while at the same time they must keep the costs for the customer as constant as possible.

Moreover, with respect to the installations or machines the wood material board producers are forced for economic reasons to practice stringent economics not only with respect to the installation or machine costs, but also the operating costs, especially in the energy area. This task is usually passed on to the installation or machine manufacturers, who make the production systems and have to prove in the keen competition that it is possible to produce at minimum energy costs.

The underlying prior art, from which the invention proceeds, is U.S. Pat. No. 4,364,984 A, which deals with the manufacture of OSB (oriented strand boards). In this prior art design, tree logs are sliced specifically in a flaker, in order to obtain wide flakes, which are stored in a storage bin and are then further processed in a hammer mill. Then the flakes are fed into a dryer, where they are dried. After drying, the flakes are classified and separated into several fractions. The results are a plurality of useable fractions and a fraction of non-useable wide flakes, which may or may not be comminuted once more. The other fractions are admixed with adhesive to form separate strands and are then conveyed to the metering bins. Then these strands are discharged in a metered manner into distribution machines, in order to form a mat of strand material on a molding belt. Then the mat is compressed continuously or discontinuously into a wood material board.

This basic design of the work flow—comminuting, drying, classifying, optionally admixing with adhesive and then distributing into a mold the base material that can then be compressed—has not changed recently.

DE 21 19 397 B2 discloses a method and a configuration for recycling the waste material that has accumulated while sawing wood. In this method the waste material is screened upstream of the dryer. However, the screening process upstream of the dryer is not used for classifying and separating into several fractions, but rather the material that is unsuited for the dryer is first removed by the screening process, and then, if desired, post-processed. Then all of the usable material is fed into the dryer and, thereupon, the dried material is screened once more.

To date the professional circles of this particular art have known that the advantages of screening after the drying process lie in being able to carry out the screening process more efficiently so that it can be of higher value. Then it is only necessary to redesign the dryer in such a way that all of the fractions can be dried. The separation of the fine and ultrafine fractions from the remaining fractions of strand material is also considered to be especially problematic, if the strand material before drying still exhibits a high moisture content—thus, is still green. The adhesive bonds between the fine material and the coarse material were too strong to guarantee proper screening.

In the meantime, however, the energy costs are a significant factor that can be expected to rise in the cost calculations for the production of wood material boards. Basically the lion's share of the energy cost is spent on drying the strand material, close upon the heels of which are the energy costs for the compression process.

### SUMMARY OF EMBODIMENTS

An inventive method and an inventive installation or machine are disclosed in which the energy costs for drying the strand material during the production of wood material boards can be reduced. This applies to the manufacture of all types of wood material boards composed of moist stock material, if this material is supposed to be dried by means of a drying device before the compression process and is supposed to be separated into several fractions. At the same time it is irrelevant whether after the screening process just one fraction shall be used in the next phase of the manufacturing process. However, the present method and the installation or machine are especially preferred for manufacturing oriented strand boards (OSB).

According to a disclosed inventive method, when the strand material is still in the moist or rather green state, it is sieved with a screening device into at least two different fractions of strand material. In this case at least one of the screened fractions is fed to at least one dryer, and, in so doing, the feeding of the strand material to at least one dryer is carried out by means of a conveying device, which is controlled by a control unit. In this context the control unit guarantees a uniform specified weight and/or volume input into the dryer(s) by means of a measurement of the mass and/or the weight per unit area of the strand material using a measuring device.

The screening device for classifying the green strand material is disposed in the installation or machine upstream of at least one dryer, and between the screening device and the dryer there is at least one conveying device, which can be controlled by a control unit and which exhibits a measuring device for measuring the mass and/or the weight per unit area of the strand material.

The installation or machine is provided for carrying out the method, but can also be used and operated independently. The targeted separation by screening the individual fractions out of all of the existing strand material makes it possible to exclude material from the next phase of the manufacturing process as early as before the time consuming and expensive drying process. For example, the ultrafine fraction (fine material) is not needed in the production of oriented strand boards. In the past, the fine material was removed from the production process after the drying process and, in so doing, caused considerable expenses because of the drying of the fine material. Classifying before the drying process yields many advantages for the disclosed method and for operating the installation or machine. In addition to the potential savings, generated through the use of just specific materials, with respect to just the drying process alone there is the possibility of charging the dryer with uniform materials of the same or rather similar size and, in so doing, to significantly increase the efficiency of the dryer. In addition, the installation or machine has a control unit, which can change several control variables in the system of the installation or machine for the uniform dryer input. In one embodiment there is between the screening device and the dryer a metering bin for the already fractionated and still moist strand material. This metering bin can optimally compensate for the variations in the volume or mass of the strand material coming out of the screening device. It is clear to the observer that the distribution device will not always deliver over time uniform quantities of fractions, but rather that in a first period a large amount of strand material and a small amount of fine material will be screened out and that in a second period a large amount of fine material and a small amount of strand material will be screened out. Thus, a metering bin can easily compensate for these disturbing variables. At the same time, variations in the density or volume in the discharge of the metering bin can be easily eliminated through adjustments that are made through a suitable conveying response of the metering bin (discharge rollers, bin floor belt). If at this stage there is no metering bin acting as a moist chip storage bin upstream of the dryer, then the respective conveying device can easily render the input into the dryer slightly more uniform through its speed in that the conveying speed of the conveying device is adjusted by the control unit.

However, in an expanded automatic control circuit the conveying device can also change the amount of the material input into the distribution device or also the ratio of the individual fractions relative to each other, in order to satisfy with respect to automatic control engineering the requirements of a uniform charging of the dryer.

In an additional preferred embodiment three fractions from the moist strand material are produced. In this context, the fine material is not dried and is eliminated from the next phase of the process, and the two other fractions consist of short flakes for the center layer and long flakes for the cover layers of an oriented strand board. In this case two dryers are necessary. Fine material is defined in this context as material of less than 3 mm mesh width.

A crucial advantage that is gained with the moist screening out process is that the flakes exhibit or better the strand material exhibits a higher starting temperature upstream of the press, because it is no longer necessary to carry out a dry screening. In this case it is possible to reduce not just the energy costs incurred during the drying process but also during the compression of hotter material. After the drying process, the mandatory cyclone can be constructed in an advantageous way as a “poor” cyclone. A good cyclone would also extract the fine contents from the air of the dryer and leave them in the manufacturing process, a poor cyclone drags the fine contents from the dried material along with the removed air.

With respect to the screening device a Quadradyn® screen is preferably used. This screen is disclosed in DE 602 19 423 T2. This screening device consists of rotating rollers (roller screen) that are arranged in parallel to each other in multiple rows. In this case the classifying disks are mounted on the rollers. Preferably the classifying disks exhibit a rectangular shape and mesh with each other in the manner of a comb. Preferably this roller screen is 2 m wide and about 10 m long. This innovation makes it possible to loosen in an outstanding way the basic material that is still in the “green” state. This device is also able to produce, as a function of its design, a number of different fractions—for example, fine material, medium coarse material for the core layer and the remaining coarse material for the two cover layers of a wood material board.

Other advantageous strategies and embodiments of the subject matter of the invention are apparent from the following description with reference to the drawing.

### BRIEF DESCRIPTION OF THE DRAWING

FIG. 1 shows an exemplary embodiment of the disclosed machine and exemplary flow sequence of the disclosed method.

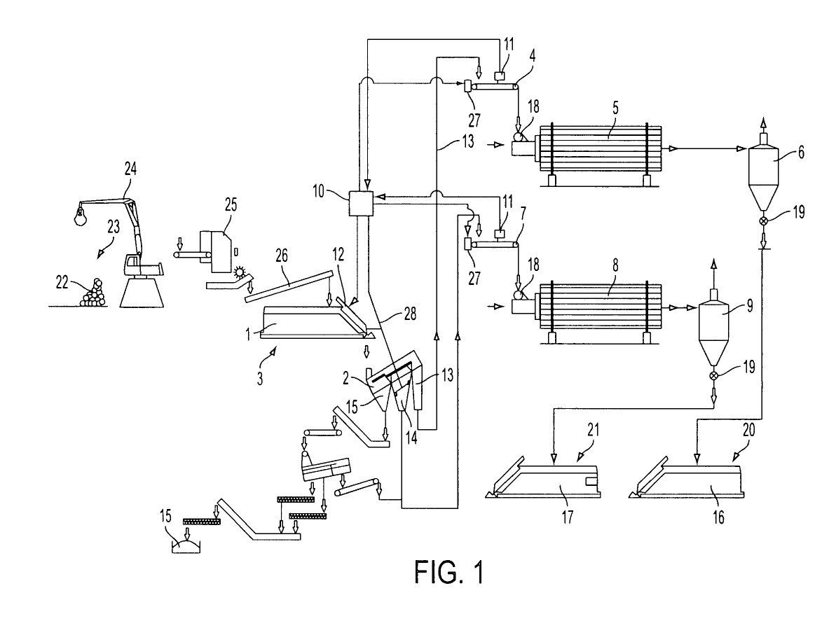

### DETAILED DESCRIPTION

The present installation or machine is used preferably for manufacturing OSB, but can also be used with suitable modifications for manufacturing other wood material boards. In a timber yard 23 tree logs 22 are stockpiled in the green or rather still moist state and fed to a flaker 25 by means of a loading device 24. Then the flaker 25 produces with its knife configurations predetermined sizes of flakes or rather strand material 1. It is clear that not only large strand material 1 can be produced, but also dust and fine material is generated that clings to the moist or rather still green strand material 1. Then a conveying device 26 conveys the strand material 1 into a moist storage bin 3. The moist storage bin 3 exhibits a discharge device 12, which provides for a controlled delivery of the strand material 1 onto the screening device 2. A Quadradyn® classifying device is proposed as the screening device 2, which separates the green strand material 1 preferably into three fractions. The first fraction is the fine material 15, which is conveyed downstream of the screening device through additional treatment and classifying devices, in order to return, if desired, the still usable material into the next phase of the manufacturing process. Then the excess fine material 15 is stored and can be used either separately for other manufacturing processes or is delivered to a controlled combustion, in order to generate energy and heat. After the fine material 15 has been removed from the strand material 1, the medium sized strand material 14 is extracted. In the subsequent phase of the manufacturing process this medium sized strand material forms the basis for the center layer of an oriented strand multilayer wood material board. After extracting, the strand material 14 is delivered to a conveying device 7, which is shown here as a conveyor belt and conveys the strand material 14 via a lock 18 into a dryer 8. At the same time the measuring device 11, which is part of the conveying device 7, measures the mass and/or the weight per unit area of the strand material 14 and, in so doing, reports the measurement results back to the control unit 10, which controls in the typical control engineering practice the speed of the conveying device 7 by means of the drive 27 and, thus, the discharge as a function of the predetermined desired size, so that the dryer 8 is charged uniformly and continuously with strand material 14 and, thus, works in the optimal efficiency range. Downstream of the dryer 8 there is a cyclone 9, which separates the drying air from the strand material 17, which is dried at this stage. At this point the dry strand material 17 for the center layer is discharged via the lock 19 and conveyed into a dry chip storage bin 21. Depending on the process sequence, the strand material 17 can be admixed with adhesive on the way to storage bin 21. The next step after the dry chip storage bin 21 is the admixing with adhesive (in the event that it has not already taken place) and the deposition of the strand on a molding belt for producing a center layer of a compressible mat of strand material. The rest of the manufacturing sequence of the wood material board is known to the person skilled in this art and, hence, does not have to be repeated at this point. To this end, reference is made to the above described state of the art.

Following separation of the medium sized strand material 14 from the original strand material 1, the strand material 13 still remains in the distribution device 2. In the subsequent manufacturing process this strand material forms the basis for the cover layers in an oriented strand multilayer wood material board. Following extraction, the strand material 13 is delivered to a conveying device 4, which is also shown here as a conveying belt and which conveys the strand material 13 through a lock 18 into a dryer 5. At the same time the measuring device 11, which is part of the conveying device 4, measures the mass and/or the weight per unit area of the strand material 13 and, in so doing, reports the measurement results back to the control unit 10, which controls in the typical control engineering practice the speed of the conveying device 4 by means of the drive 27 and, thus, the discharge as a function of the predetermined desired size. In this way the dryer 5 is charged uniformly and continuously with strand material 13 and is held in the optimal efficiency range. Downstream of the dryer 5 there is a cyclone 6, which separates the drying air from the strand material 16, which has been dried at this stage. At this point the dry strand material 16 for the cover layers is discharged via a lock 19 and conveyed into a dry chip storage bin 20. Depending on the process sequence, the strand material 16 can be admixed with adhesive on the way to storage bin 20. The next step after the dry chip storage bin 20 is the admixing with adhesive (in the event that it has not already taken place) and the deposition of the strand on a molding belt for producing the two cover layers of a compressible mat of strand material.

Preferred embodiments for adapting and/or optimizing the manufacturing process and/or the installation or machine shall be presented below. The measurement of the strand material 13, 14 can be carried out gravimetrically with a weight per unit area scale and/or with a transirradiation device as a measuring device 11 on the conveying devices 4, 7. A metering bin is also conceivable as a conveying device. The metering bin can be operated in a more adjustable way with respect to disturbing sizes and can feed the respective fraction of strand material 13, 14 into the dryer 5, 8 by means of a discharge belt, the speed of which can be adjusted by a drive 27. For an expanded automatic control circuit the control unit 10 can adjust, as a function of the demand, the amount of strand material that is delivered onto the screening device 2, per unit of time and/or the ratio of fractions in relation to each other downstream of the screening device 2. This approach is used preferably if the conveyor belt is used as a conveying device 4, 7, in order to be able to better compensate for the variations in input into the dryers 5, 8. In this context, flaps can also be mounted below the roller screen of the screening device 2. These flaps can be used to change the ratio of the strand material 13 to the strand material 14. If, for example, over a prolonged period of time (owing to the poor quality of the wood or flaking errors) too little large strand material 13 is discharged in the direction of the dryer 5 and is detected by the measuring device 11 of the related conveying device 4, the control unit 10 can intervene in a controlling manner by way of a flap control system 28 on the screening device 2 and can increase the amount of strand material 13 per unit of time, if it is predictable that a short term increase in the speed of the conveying device 4 will not be adequate. It is a given that this strategy can also be undertaken analogously in the case of the other fractions from the strand material 1.

Besides the produced strand material 1, material that has been delivered separately can also be fed into the manufacturing process upstream of the screening device 2 and then admixed. After drying the strand material 13, 14 in the dryers 5, 8, the extraction can be conducted with a “poor” cyclone 6, 9, in order to remove the fine contents or dust, which have not been separated out by the screening device, from the dried strand material 13, 14 with the drying air and to extract separately, if desired, before returning the drying air into the dryers 5, 8.

Alternative preferred embodiments are set out below. According to alternative embodiment one, a method for screening and drying strand material (1) upstream of a distribution machine in the course of manufacturing wood material boards, wherein the strand material (1) consists of flakes, chips or similar lignocellulose containing material and, following delivery or manufacturing, is subjected to a drying process and optionally admixing with adhesive and then is deposited on a molding belt in a distribution station to form a mat of strand material and in the next phase of the process is compressed with pressure and heat into a wood material board, is characterized in that the strand material (1) still in the moist state is screened with a screening device 2 into at least two different fractions of strand material (13, 14), wherein at least one of the screened fractions is fed to at least one dryer (5, 8), and wherein the feeding of the strand material (13, 14) to at least one dryer (5, 8) is carried out by means of a conveying device (4, 7), which is controlled by a control unit (10), and wherein the control unit (10) guarantees a uniform, predetermined weight and/or volume input into the dryer(s) (5, 8) by measuring the mass and/or the weight per unit area of the strand material (13, 14) by means of a measuring device (11).

According to alternative embodiment two, a method according to alternative embodiment one is characterized in that the measurement is carried out gravimetrically with a weight per unit area scale and/or with a transirradiation device as the measuring device (11). According to alternative embodiment three, a method according to alternative embodiment one or two is characterized in that the conveying device (4, 7) conveys the respective fraction of the strand material (13, 14) into the dryer (5, 8) by means of a conveyor belt, the speed of which can be adjusted by a drive (27). According to alternative embodiment four, a method according to any of alternative embodiments one through three is characterized in that the conveying device (4, 7) conveys the respective fraction of the strand material (13, 14) into the dryer (5, 8) by means of a discharge belt of a metering bin, the speed of which can be adjusted by a drive (27). According to alternative embodiment five, a method according to any of alternative embodiments one through four is characterized in that in an expanded automatic control circuit the control unit (10) can adjust the amount of the strand material that is delivered onto the screening device (2), per unit of time and/or the ratio of the fractions in relation to each other downstream of the screening device (2).

According to alternative embodiment six, a method according to any of alternative embodiments one through five is characterized in that the strand material (1) in the moist state is stored in a moist storage bin (3) upstream of the screening device (2). According to alternative embodiment seven, a method according to any of alternative embodiments one through six is characterized in that the different fractions of delivered and/or produced strand material are mixed upstream of the screening device (2). According to alternative embodiment eight, a method according to any of alternative embodiments one through seven is characterized in that the screening in the screening device (2) is carried out with a roller screen. According to alternative embodiment nine, a method according to any of alternative embodiments one through eight is characterized in that the screening in the screening device (2) is carried out with a Quadradyn® screen. According to alternative embodiment ten, a method according to any of alternative embodiments one through nine is characterized in that after the screening in the screening device (2) the ratio of the individual fractions of the strand material (13, 14) can be adjusted in relation to each other by means of a flap.

According to alternative embodiment eleven, a method according to any of alternative embodiments one through ten is characterized in that after the drying process in the dryer (5, 8), the extraction is conducted with a “poor” cyclone (6, 9), in order to remove the non-separated fine fractions or dust from the dried strand material (13, 14). According to alternative embodiment twelve, a method according to any of alternative embodiments one through eleven is characterized in that after drying in the dryer (5, 8), the strand material (16, 17) is conveyed into a dry chip storage bin (20, 21) and is then fed to the optional admixing with adhesive or directly to a distribution station. According to alternative embodiment thirteen, a method according to any of alternative embodiments one through twelve is characterized in that in order to manufacture OSB, the strand material (1) still in the moist state is separated with a screening device (2) into at least three fractions of the strand material (13, 14) and fine material (15) wherein the ultrafine fraction—the strand material 15—is removed from the manufacturing process, wherein the medium fraction—the strand material 14—is used to form the center layer of the mat of strand material, and the coarse fraction—the strand material 13—is used to form the cover layers of the mat of strand material. According to alternative embodiment fourteen, a method according to any of alternative embodiments one through thirteen is characterized in that the fractions of the strand material (13, 14) are conveyed into a separate dryer (5, 8).

According to alternative embodiment fifteen, an installation or machine for screening and drying strand material (1) upstream of a distribution machine in the course of manufacturing wood material boards, comprising a screening device (2), at least one dryer (5, 8) with an optional cyclone (6, 9), is characterized in that the screening device (2) for classifying the green strand material (1) is disposed upstream of at least one dryer (5, 8) in the installation or machine, and that between the screening device (2) and the dryer (5, 8) there is at least one conveying device (4, 7), which can be controlled by a control unit (10) and which exhibits a measuring device (11) for measuring the mass and/or the weight per unit area of the strand material (13, 14).

According to alternative embodiment sixteen, an installation or machine according to alternative embodiment fifteen is characterized in that a weight per unit area scale and/or a transirradiation device is (are) provided as the measuring device (11). According to alternative embodiment seventeen, an installation or machine according to alternative embodiments fifteen or sixteen is characterized in that the control unit (10) is connected to the drive (27) of the conveying device (4, 7) and/or to the discharge device of the moist storage bin (3) and/or to the flap control system (28) of the screening device (2). According to alternative embodiment eighteen, an installation or machine according to any of alternative embodiments fifteen through seventeen is characterized in that a Quadradyn® classifying device is provided as the screening device (2). According to alternative embodiment nineteen, an installation or machine according to any of alternative embodiments fifteen through eighteen is characterized in that a “poor” cyclone (6, 9) is arranged as a cyclone downstream of the dryer.

In a fundamentally different embodiment for manufacturing, the manufacturing process and an installation or machine can be designed as follows. The screening device 2 classifies the strand material 1 into only two fractions. In this case one fraction is used for manufacturing a chip board, and the other fraction is sorted out of the process. At the same time a drum screen, which exhibits, for example, an aperture width of 3 mm, can also be used as the screening device 2.

Modifications may be made without departing from the spirit or scope of the inventive concepts as defined by the appended claims and their equivalents.

What is claimed is:

1. A method for screening and drying moist strand material, comprising:
screening, with a screening device located upstream of a distribution machine in the course of manufacturing wood material boards, the moist strand material into a plurality of fractions, the moist strand material of a first fraction being sized differently than that of a second fraction;
conveying the first fraction on a conveying device controlled by a control unit, wherein the control unit is coupled to a measuring device that measures at least one of mass per unit area of the first fraction and weight per unit area of the first fraction; and
feeding the first fraction into a first dryer.

2. The method of claim 1, wherein the measuring device comprises at least one of a weight per unit area scale and a transirradiation device.

3. The method of claim 1, wherein the conveying device comprises a conveyor belt coupled to a drive, and wherein the conveyor belt conveys the first fraction into the first dryer at a speed of the conveyor belt, and wherein the speed of the conveyor belt can be adjusted by the drive.

4. The method of claim 1, wherein the conveying device comprises a metering bin, wherein the metering bin is coupled to a drive and includes a discharge belt, and wherein the discharge belt conveys the first fraction into the first dryer at a speed of the discharge belt, and wherein the speed of the discharge belt can be adjusted by the drive.

5. The method of claim 1, wherein the control unit controls an amount of moist strand material screened into each of the plurality of fractions.

6. The method of claim 1, further comprising storing the moist strand material in a storage bin upstream of the screening device.

7. The method of claim 1, wherein the moist strand material upstream of the screening device comprises short flakes, long flakes, and fine material.

8. The method of claim 1, wherein the screening device comprises a roller screen.

9. The method of claim 1, wherein the screening device comprises a Quadradyn screen.

10. The method of claim 1, wherein a flap control system is coupled to the control unit and the screening device, and wherein the flap control system controls the amount of screened moist strand material contained in each fraction.

11. The method of claim 1, further comprising:
drying the first fraction in the first dryer, wherein the moist strand material becomes dried strand material;
extracting the first fraction of dried strand material with a “poor” cyclone.

12. The method of claim 1, further comprising:
drying the first fraction in the first dryer, wherein the moist strand material becomes dried strand material;
conveying the dried strand material into a dry chip storage bin; and
feeding the dried strand material to a distribution station.

13. The method of claim 1, wherein the screening device screens the moist strand material into three fractions, wherein the three fractions are an ultrafine fraction removed from the manufacturing process, a medium fraction used to form center layers of a mat of strand material, and a coarse fraction used to form cover layers of the mat of strand material.

14. The method of claim 1, wherein each of the plurality of fractions of moist strand material is conveyed to a separate dryer.

15. An installation for screening and drying moist strand material, the installation located upstream of a distribution machine for manufacturing wood material boards, comprising:
a screening device located upstream of a first dryer and configured to screen the moist strand material; and
a conveying device connected to a control unit and located between the screening device and the first dryer, wherein the control unit comprises a measuring device configured to measure at least one of mass per unit area of moist strand material and weight per unit area of moist strand material.

16. The installation of claim 15, wherein the measuring device comprises at least one of a weight per unit area scale and a transirradiation device.

17. The installation of claim 15, further comprising:
a moist storage bin located upstream of the screening device and coupled to a discharge device; and
a flap control system coupled to the screening device,
wherein the conveying device is coupled to a drive, and
wherein the control unit is connected to at least one of the drive, the discharge device, and the flap control system.

18. The installation of claim 15, wherein the screening device comprises a Quadradyn®-like classifying device.

19. The installation of claim 15, wherein a “poor” cyclone is located downstream of the first dryer.
